(19) United States
(12) Patent Application Publication
(10) Pub. No.: US 2010/0236890 A1
(43) Pub. Date: Sep. 23, 2010

(54) Mechanical Clutch Having Polymer Engagement

(76) Inventor: Dave Hampson, Oak Creek, WI (US)

Correspondence Address: BOYLE FREDRICKSON S.C., 840 North Plankinton Avenue, MILWAUKEE, WI, 53203, US

(21) Appl. No.: 12/708,639

(22) Filed: Feb. 19, 2010

Related U.S. Application Data
(60) Provisional application No. 61/154,124, filed on Feb. 20, 2009.

(51) Int. Cl. F16D 43/18; F16D 13/14

(52) U.S. Cl. 192/103 B

(57) ABSTRACT

A polymer based clutch system for using as a centrifugal clutch. The clutch includes a clutch hub configured to rotationally adhere to an engine crankshaft and a polymer clutch configured to mate with the clutch hub and having a deformity property configured to correlate to a desired RPM of the engine crankshaft.

### CROSS REFERENCE TO RELATED APPLICATIONS

This application claims the benefit of U.S. Provisional Application No. 61/154,124, filed Feb. 20, 2009, hereby incorporated by reference in its entirety.

### BACKGROUND

The present invention relates to a mechanical clutch. More particularly, the present invention relates to a mechanical clutch having a polymer component providing engagement.

Clutches are useful in devices that have two rotating shafts. In these devices, one of the shafts is typically driven by a motor or pulley, and the other shaft drives another device. In a starter engine, for instance, one shaft is driven by a motor and the other drives a primary drive shaft. The clutch connects the two shafts so that they can either be locked together and spin at the same speed, or be decoupled and spin at different speeds.

One type of clutch is a centrifugal clutch that uses centrifugal force to connect two concentric shafts, with the driving shaft nested inside the driven shaft. Centrifugal clutches can be used in a variety of types of equipment such as lawn and garden equipment, chainsaws, construction equipment, ATVs, motorcycles, snowmobiles, utility vehicles, go karts, dirt and ice augers, water pumps, string trimmers, door governors, and fuel powered model cars. Centrifugal clutches are often used to prevent damage to an engine or motor during operation, provide low load during starting, and allow an engine to idle.

In a typical centrifugal clutch, the input of the clutch is connected to an engine crankshaft while the output may drive a shaft, chain, or belt. As engine RPM increases, rotating the engine crankshaft, weighted arms in the clutch swing outward and force the clutch to engage. The most common types of centrifugal clutches have friction pads or shoes radially mounted that engage the inside of the rim of a housing connected to the driven shaft. On the center shaft there are an assorted amount of extension springs, which connect to a clutch shoe. When the center shaft spins fast enough, the centrifugal force overcome the tension of the springs extend causing the clutch shoes to engage the friction face of the inside rim of the housing.

The spring-based centrifugal clutch requires proper tensioning and operation of the springs anchoring the weighted arms to the engine crankshaft in order to engage and disengage properly. However, springs, after extended periods of tensioning and detensioning, can change their operating characteristics or even fail completely. Further, during manufacture, workers are required to attach the springs to one or more clutch shoes, occasionally utilizing specialized equipment. Accordingly, using spring may also increase manufacturing time and expense.

What is needed is a clutch configured to utilize a polymer based clutch tensioning and engagement system to engage and disengage an engine crankshaft with a driven shaft. The engine crankshaft and the driven shaft may stay engaged until the engine is turned off, may stay engaged until the engine idles, or for any other duration. What is further needed is such a clutch that does not require clutch shoes or plates or other systems for clutch engagement. What is yet further needed is such a system configured to be a one piece clutch engagement and tensioning system.

### BRIEF SUMMARY

According to a first aspect, a polymer based clutch system for using as a centrifugal clutch. The clutch includes a clutch hub configured to adhere with a thread, keyed shaft, screws and/or other attachment to an engine crankshaft and a polymer clutch configured to mate with the clutch hub and having a deformity property configured to correlate to a desired RPM of the engine crankshaft.

These particular features and advantages may apply to only some embodiments falling within the claims and thus do not define the scope of the invention. The following description and figures illustrate a preferred embodiment of the invention. Such an embodiment does not necessarily represent the full scope of the invention, however. Furthermore, some embodiments may include only parts of a preferred embodiment. Therefore, reference must be made to the claims for interpreting the scope of the invention.

### BRIEF DESCRIPTION OF THE DRAWINGS

FIG. 1 is an isometric view of a mechanical clutch having a polymer clutch, according to an exemplary embodiment;

FIG. 2A is a top view of one embodiment of the polymer clutch of FIG. 1, according to an exemplary embodiment;

FIG. 2B is an isometric view of the polymer clutch of FIG. 2A, according to an exemplary embodiment;

FIG. 3A is a top view of one embodiment of the polymer clutch of FIG. 1, according to an exemplary embodiment;

FIG. 3B is an isometric view of the polymer clutch of FIG. 2A, according to an exemplary embodiment;

FIG. 4A is a top view of one embodiment of the polymer clutch of FIG. 1, according to an exemplary embodiment;

FIG. 4B is an isometric view of the polymer clutch of FIG. 2A, according to an exemplary embodiment;

FIG. 5A is a top view of one embodiment of the polymer clutch of FIG. 1, according to an exemplary embodiment;

FIG. 5B is an isometric view of the polymer clutch of FIG. 2A, according to an exemplary embodiment;

FIG. 6A is an isometric view of one embodiment of the polymer clutch of FIG. 1 having a plurality of inserts, according to an exemplary embodiment;

FIG. 6B is a top view of the polymer clutch of FIG. 2A, according to an exemplary embodiment;

FIG. 7A is a top view of one embodiment of the polymer clutch of FIG. 1 having a plurality of weighted inserts, according to an exemplary embodiment; and

FIG. 7B is an isometric view of the polymer clutch of FIG. 2A, according to an exemplary embodiment;

### DETAILED DESCRIPTION

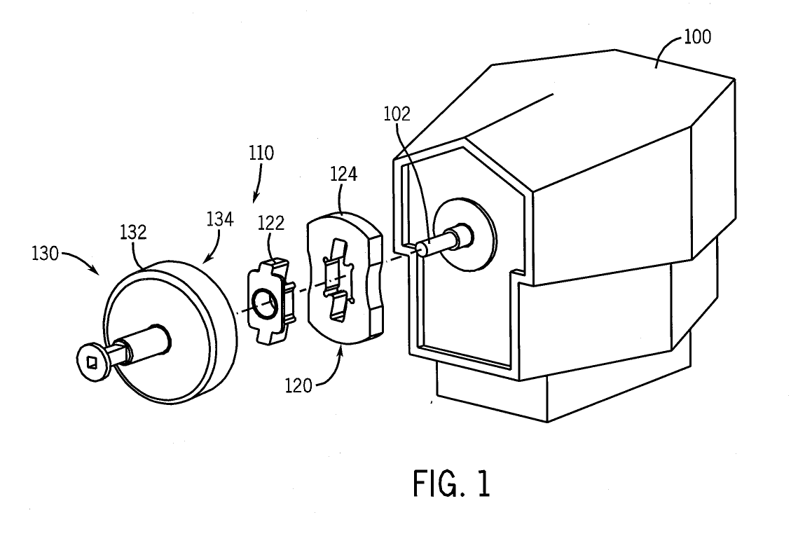

Referring now to FIG. 1, an isometric view of an engine 100 driving a mechanical clutch system 110 having a polymer based clutch system 120 is shown, according to an exemplary embodiment. In the exemplary embodiment, polymer based clutch system 120 and mechanical clutch system 110 are configured as a centrifugal clutch system. Although shown and described with reference to such applications, one of ordinary skill in the art would understand that the described mechanical clutch may be used with a variety of engine types of varying horsepower in a variety of clutch configurations, consistent with the description herein.

Engine 100 may be any type of engine or motor having a shaft providing rotational output (shown as engine crankshaft 102). Engine 100 may be a starter engine configured for use in lawn and garden equipment, motorcycles, etc. Although a specific type and configuration of engine 100 is shown in FIG. 1, one of ordinary skill in the art would understand that the described clutch system is not limited to use with this type and configuration of engine. Engine 100 may further be configured such that the rotational output provided by engine crankshaft 102 is at a RPM sufficient to overcome an inherent elasticity of a polymer clutch 124, as described below in further detail.

Clutch 120 is a centrifugal clutch having a clutch hub 122 and a polymer clutch 124. Although particular embodiments of clutch hub 122 and clutch 124 are shown and described herein, it should be understood by one of skill in the art that a number of different configurations and types of clutch hubs and polymer based engagement and disengagement systems may be used to provide polymer based engagement and tensioning in a mechanical clutch.

Clutch hub 122 is configured to be a removable hub coupled rotationally, keyed, or held with a set screw to engine crankshaft 102 such that the rotational energy of crankshaft 102 is directly transferred to clutch hub 122. Clutch hub 122 is configured to receive and secure system 124 such that the rotational energy of crankshaft 102 is further transferred directly to system 124. Accordingly, in an engaged state, crankshaft 102, clutch hub 122 and system 124 will rotate in sync based on the power provided by engine 100. Clutch hub 122 may be made of any type of material that can withstand the rotational energy provided by engine 100 such as plastic or metal. Clutch hub 122 may further have curved or straight legs. Clutch hub 122 may further be configured to include a retaining feature to prevent the polymer clutch 124 from moving axially. Clutch hub 122 may further be integrally molded within polymer clutch 124 or may be a separate component.

Polymer clutch 124 is a polymer based clutch that implements tensioning based on an inherent elasticity of both the polymer and the shape of the polymer based clutch. Polymer clutch 124 further is configured to implement engagement and disengagement between engine crankshaft 102 and a primary drive shaft assembly 130 based on a friction based engagement that occurs when the RPM of the engine crankshaft 102 is sufficient to overcome the inherent elasticity of the polymer based clutch, discussed with further detail below. Engagement occurs when the deformity of polymer clutch 124 is sufficient to couple engine crankshaft 102 to primary drive assembly 130 such that rotational energy is transferred. Disengagement occurs when no energy is being transferred.

The type of polymer used to create polymer clutch 124 may be selected in order to create a polymer clutch having desired deformity property. The deformity property may be based on the type of polymer used to create the polymer clutch, each type of polymer having an inherent polymer that either increases or decreases the deformity property. The deformity property may be the elasticity of the clutch 124 such that, at or above a given RPM, clutch 124 will distend sufficiently to couple engine crankshaft 102 to drive assembly 130. Exemplary polymers may include, but are not limited to urethane, carboxylated nitrile, and hydrogenated nitrile rubber (HNRB) nitrile. The type of polymer utilized may be select based on one or more desired properties such as friction coefficient, durability, heat resistance, cost, response to temperature, wear characteristics, availability, hardness, and elasticity.

The physical configuration of polymer clutch 124 may also be selected based on a desired deformity property. Physical configuration variables including, but not limited to shape, internal openings, thickness, etc., may also be selected in order to create a polymer clutch having desired deformity property. The physical configuration may be selected based on the factors described above with reference to the selection of a type of polymer as well as the type of polymer that was selected.

Primary drive shaft assembly 130 may be a drive shaft configured to be rotationally coupled to engine crankshaft 102 based upon engagement of the clutch assembly 120. Primary drive shaft assembly may include a drum assembly 132 having an inside rim 134 configure to frictionally engage with clutch 120 when the RPM of the engine crankshaft 102 is high enough to provide sufficient deformity to polymer clutch 124 such that clutch 124 engages with inside rim 134. Drum assembly 132 may be directly coupled to an output shaft, may be couple to a pulley connected to an output by a belt or chain, or any other method for transferring the rotational energy to the output shaft.

Advantageously, using a polymer based clutch allows softer and quieter engagement between the engine crankshaft 102 and the drum assembly 132. Softer engagement occurs because the metal shoes typically used in clutches are replaced by the polymer clutch. The frictional interaction between clutch 124 and inside rim 134 is less likely to cause wear to inside rim 134 compared to a clutch having one or more metal clutch shoes tensioned by springs. The frictional interaction will further create less noise in the period between clutch contact with inside rim 134 and frictional engagement.

A polymer based clutch 124 may further provide a better engagement with inside rim 134 compared to a clutch having one or more metal shoes. The elasticity of a polymer based clutch allow the clutch to deform more than a metal shoe would to mate with any imperfections in inside rim 134 to provide stronger engagement. Accordingly, the deformity property of clutch 124 may be configured based on a desired engagement with inside rim 134 beyond an initial contact and frictional engagement with inside rim 134.

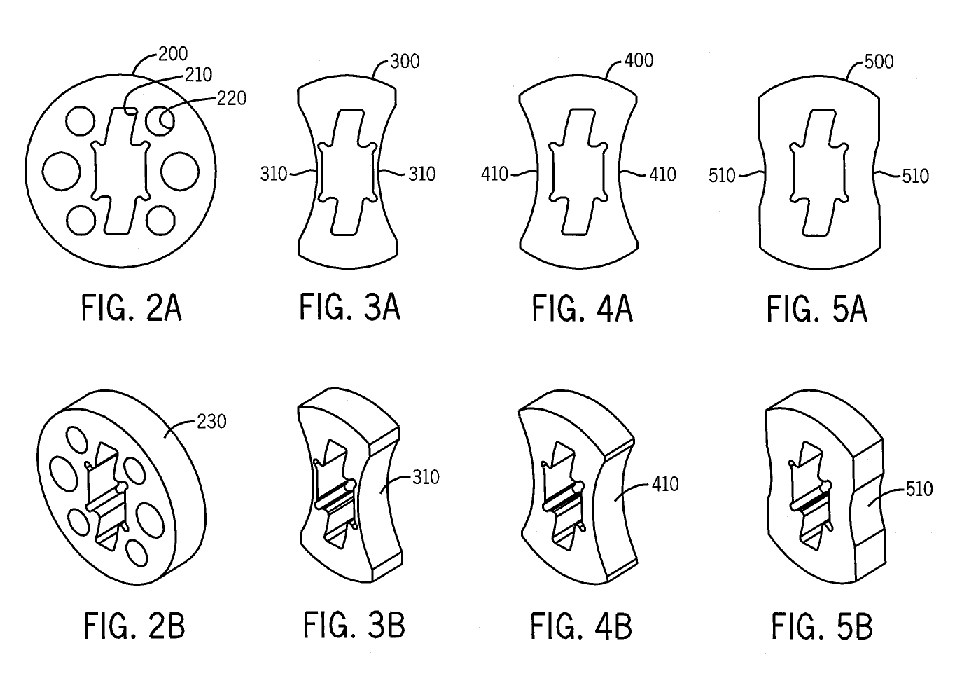

Referring now to FIGS. 2A and 2B, a top and an isometric view of one embodiment 200 of the polymer clutch 124 is shown, according to an exemplary embodiment. Clutch 200 includes a clutch hub opening 210, engagement openings 220, and a clutch thickness 230.

Clutch hub opening 210 is configured to mate with clutch hub 122 such that rotation of clutch 120 causes substantially uniform rotation of clutch hub 122 and clutch 124. The shape of clutch hub opening 210 may be configured based on the shape of clutch hub 122.

Engagement openings 220 may be one or more openings in clutch 200 configured to modify the deformity property of the clutch 200. The number, location, and size of the engagement openings may be configured to increase or decrease the deformity property of clutch 200. For example, a number of large openings may be provided where it is desirable to reduce the RPM for engine crankshaft 102 that would be required before the clutch 200 would deform sufficiently to provide engagement with inside rim 134

Clutch thickness 230 may further be configured based on a desired wear prevention or desired capacity property of clutch 200. Capacity is the amount of energy that can be transmitted through the clutch. For example, a thicker embodiment of clutch 200 would allow more energy to be transferred.

Referring now to FIGS. 3A-5A and 3B-5B, a plurality of top and isometric views of embodiments 300, 400, and 500, respectively, of the polymer clutch 124 is shown, according to an exemplary embodiment. Clutches 300, 400, and 500 includes a clutch hub opening 210 and a clutch thickness 230 similar to clutch embodiment 200. Clutches 300, 400 and 400 further include different permutations of engagement cuts 310, 410 and 510. The size of the engagement cuts affects the amount of deformity of the clutch when rotational energy is applied.

Clutch 300 may be configured to be a low engagement clutch having relatively larger engagement cuts 310. Larger engagement cuts modify the deformity property of clutch 300 such that a lower RPM for engine crankshaft 102 would be required before the clutch 300 would deform sufficiently to provide engagement with inside rim 134. Similarly, clutch 400 may be configured to have standard engagement cuts 410 and clutch 500 may be configured to have smaller engagement cuts 510 to provide a standard and a smaller deformity property, respectively.

Although engagement openings and cuts are shown a described with reference to clutches 200-500, it should be understood that any removal, shaping, and/or addition of polymer material can be used to modify the deformity property of a polymer based clutch. Examples include slots, hourglass shaping, variable thickness across a radius of a clutch, etc.

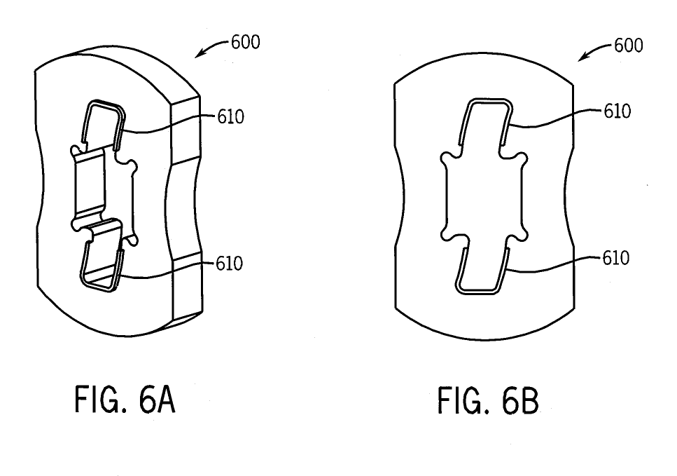

Referring now to FIGS. 6A and 6B, top and isometric views, respectively, of a polymer clutch 600 having an insert 610 is shown, according to an exemplary embodiment. Insert 610 may be any material different from the polymer inserted into the polymer clutch 600 to change the operating characteristics of polymer clutch 600. For example, as shown in FIGS. 6A and 6B, an insert 610 may be inserted lining the opening in polymer clutch 600 that receives the clutch hub 122 to provide greater rigidity at the site of the insert 610. The greater rigidity may be desirable to modify the capacity of polymer clutch 600.

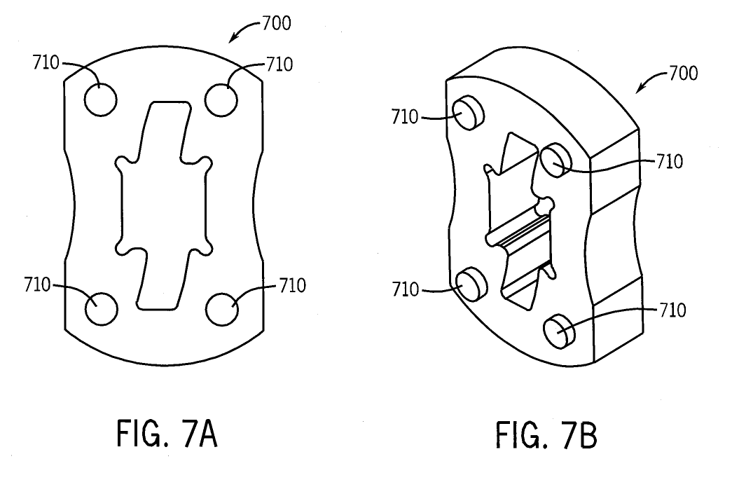

Referring now to FIGS. 7A and 7B, top and isometric views, respectively, of a polymer clutch 700 having a plurality of inserts 710 is shown, according to an exemplary embodiment. Insert 710 may be a weighted material different from the polymer inserted into the polymer clutch 700 to change the deformity property of polymer clutch 700. For example, as shown in FIGS. 7A and 7B, a plurality of inserts 710 may be inserted into the engagement openings to facilitate engagement of the clutch 700 at a lower RPM than would otherwise be obtained based on the elasticity of the polymer clutch 700.

It should be observed that the invention includes, but is not limited to, a novel structural combination of conventional components, and not in particular detailed configurations thereof. Generally, the invention can be implemented flexibly as will be appreciated by those of ordinary skill in the art. Further, the invention is not limited to the particular embodiments depicted in the exemplary embodiments, but should be construed in accordance with the language in the claims.

We claim:

1. A polymer based clutch system, comprising
a polymer clutch configured to rotationally adhere to an engine crankshaft and having a deformity property configured to correlate to a desired RPM of the engine crankshaft.

2. The clutch system of claim 1, further including a clutch hub configured to be inset into the polymer clutch and to provide the rotational adherence to the engine crankshaft.

3. The clutch system of claim 1, wherein the deformity property is configured based on a type of polymer used to form the polymer clutch.

4. The clutch system of claim 1, wherein the deformity property is configured based on a shape of the polymer clutch.

5. The clutch system of claim 1, wherein a desired capacity of the polymer clutch is configured based on a thickness of the polymer clutch

6. The clutch system of claim 5, the polymer clutch is configured to include one or more inserts to modify the deformity property and the desired capacity.

7. The clutch system of claim 1, wherein the one or more inserts is a weighted material.

8. The clutch system of claim 1, wherein configuring the polymer clutch to correlate to a desired RPM of the engine crankshaft includes inserting one or more engagement openings in the polymer clutch.

9. The clutch system of claim 1, wherein configuring the polymer clutch to correlate to a desired RPM of the engine crankshaft includes including one or more engagement cuts in the polymer clutch.

10. A polymer based clutch system, comprising
a clutch hub configured to rotationally adhere to an engine crankshaft;
a driven shaft including a drum assembly; and
a single piece clutch assembly configured to mate with the clutch hub and formed from a polymer configured to provide clutch engagement and disengagement with the drum assembly.

11. The clutch system of claim 10, wherein the clutch hub is configured to be inset into the polymer clutch assembly and to provide the rotational adherence to the engine crankshaft.

12. The clutch system of claim 10, wherein the engagement and disengagement is actuate by matching the rotational speed of the engine crankshaft to a deformity property of the polymer based on a type of polymer used to form the polymer clutch.

13. The clutch system of claim 12, wherein the deformity property is further configured based on a shape of the polymer clutch.

14. The clutch system of claim 10, wherein a desired capacity of the polymer clutch is configured based on a thickness of the polymer clutch

15. The clutch system of claim 14, the polymer clutch is configured to include one or more inserts to modify the deformity property and the desired capacity.

16. The clutch system of claim 10, wherein the one or more inserts is a weighted material.

17. The clutch system of claim 12, wherein configuring the polymer clutch to correlate to a desired rotational speed of the engine crankshaft includes inserting one or more engagement openings in the polymer clutch.

18. The clutch system of claim 12, wherein configuring the polymer clutch to correlate to a desired rotational speed of the engine crankshaft includes including one or more engagement cuts in the polymer clutch.

19. A polymer based clutch system, comprising
a clutch hub configured to rotationally adhere to an engine crankshaft;
a driven shaft including a drum assembly; and
a clutch configured to mate with the clutch hub and configured to provide clutch engagement and disengagement with the drum assembly, wherein the clutch is entirely formed from a polymer.
